(19) United States
(12) Patent Application Publication
(10) Pub. No.: US 2014/0304545 A1
(43) Pub. Date: Oct. 9, 2014

(54) RECOVERING A FAILURE IN A DATA PROCESSING SYSTEM

(71) Applicant: HEWLETT-PACKARD DEVELOPMENT COMPANY, L.P., (US)

(72) Inventors: Qiming Chen, Cupertino, CA (US); Meichun Hsu, Los Altos, CA (US)

(73) Assignee: HEWLETT-PACKARD DEVELOPMENT COMPANY, L.P., Houston, TX (US)

(21) Appl. No.: 13/857,885

(22) Filed: Apr. 5, 2013

(51) Int. Cl. H04L 12/24

(52) U.S. Cl. CPC H04L 41/0654
USPC 714/4.3

(57) ABSTRACT

A technique of recovering a failure in a data processing system comprises restoring a checkpointed state in a last window, and resending all the input messages received at the second node during the failed window boundary.

### BACKGROUND

Stream analytics provided as a cloud service has gained popularity for supporting many applications. Within these types of cloud services, the reliability and fault-tolerance of distributed streams is addressed. In graph-structured streaming processes with distributed tasks, the goal of transactional streaming is to ensure the streaming records, referred to as tuples, are being processed in the order of their generation in each dataflow path with each tuple being processed once. Since transactional streaming deals with chained tasks, computation results as well as dataflow between cascading tasks is taken into account.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a diagram of a data processing system for window-based checkpoint and recovery (WCR) data processing, according to one example of the principles described herein.

FIG. 2 is a diagram of a streaming process, according to one example of the principles described herein.

FIG. 3 is a diagram of a streaming process with elastically parallelized operator instances, according to one example of the principles described herein.

FIG. 4 is a flowchart showing task execution utilizing window-based checkpoint and recovery (WCR), according to one example of the principles described herein.

FIG. 5 is a flowchart showing task recovery utilizing window-based checkpoint and recovery (WCR), according to one example of the principles described herein.

FIG. 6 is a flowchart showing task recovery utilizing window-based checkpoint and recovery (WCR), according to another example of the principles described herein.

FIG. 7 is a flowchart showing task recovery utilizing window-based checkpoint and recovery (WCR), according to still another example of the principles described herein.

Throughout the drawings, identical reference numbers designate similar, but not necessarily identical, elements.

### DETAILED DESCRIPTION

A distributed streaming process contains multiple parallel and distributed tasks chained in a graph-structure. A task runs cycle by cycle where, in each cycle, the task processes an input stream data element called a tuple and derives a number of output tuples which are distributed to a number of downstream tasks. Reliable stream processing comprises processing of the streaming tuples in the order of their generation on each dataflow path, and processing of each tuple once and only once. The reliability of stream processing is guaranteed by checkpointing states and logging messages that carry stream tuples, such that if a task fails and is subsequently recovered, the task can roll back to the last state and have the missing tuples re-sent for re-processing.

A “pessimistic” checkpointing protocol can be used where the output messages of a task are checkpointed before sending, one tuple at a time. In a recovery based on pessimistic checkpointing, the state of the failed task is reloaded from its most recent checkpoint, and the current input is replayed. Any duplicate input would be ignored by the recipient task. However, due to the nature of blocking input messages one by one, pessimistic checkpointing protocol is very inefficient in systems where failure instances are rare, and, particularly, in real-time stream processing. In these systems, more computing resources are being utilized in pessimistic checkpointing protocol without a benefit to the overall efficiency of the data streaming system.

In environments or situations where failures are infrequent and failure-free performance is a concern, an “optimistic” checkpointing protocol may be used. An optimistic checkpoint protocol comprises asynchronous message checkpointing and emitting. For example, optimistic checkpoint protocol comprises continuously emitting, but checkpointing, with a number of messages, at a number of predefined intervals or points within the execution of a data streaming process. During the recovery of a task, the task's state is rolled back to the last checkpoint, and the effects of processing multiple messages may be lost. Further, several tasks may be performed in a chaining manner where the output of a number of tasks may be the input of a number of subsequent tasks. Since the chained tasks have dependencies, in the general distributed systems where the instant globally consistent state is pursued, rolling back a task may cause other tasks to rollback, which, in turn, may eventually lead to a domino effect of an uncontrolled propagation of task rollbacks.

According to an example, an optimistic checkpointing protocol is used in the context of stream processing where “eventual consistency” rather than instant global consistency, is pursued. Eventual consistency is where a failed-recovered task eventually generates the same results as in the absence of the failure. The window semantics of stream processing is associated with an observable and semantically meaningful cut-off point of rollback propagation, and implements the continued stream processing with Window-based Checkpoint and Recovery (WCR). With WCR, the checkpointing is made asynchronously with the task execution and output message emitting. While the stream processing is still performed tuple by tuple, checkpointing is performed once per-window. As will be described in more detail below, the window may be, for example, a time window or a window created by a bounded number of tasks. When a task is re-established from a failure, its checkpointed state in the last window boundary is restored, and all the input messages received during the failed window boundary are resent and re-processed. Thus, the WCR protocol may comprise a number of features. First, WCR protocol handles optimistic checkpointing in a way suitable for stream processing based on the notion of “eventual consistency.” Second, WCR protocol relies on window boundaries to synchronize the checkpoints of chained tasks to avoid the above-described domino effects, making the rollback propagation well controlled. Third, WCR protocol is different from batch processing because it allows each task to perform per-tuple based stream processing and emit results continuously, but with batch oriented checkpointing and recovery.

In fact, in the context of graph-structured, distributed stream processing, previous failure recovery approaches are limited to pessimistic checkpointing, and the above-described optimistic checkpoint and recovery method has not been specifically dealt with. In the present disclosure the merits of optimistic checkpointing protocol in failure recovery of real-time stream processing is disclosed. Further, “eventual consistency” rather than the pursuit of a globally consistent state is disclosed. Still further, a commonly observable and semantically meaningful cut-off point of rollback propagation is disclosed.

### DEFINITIONS

As used in the present specification and in the appended claims, the term “stream” is meant to be understood broadly as an unbounded sequence of tuples. A streaming process is constructed with graph-structurally chained streaming operations.

As used in the present specification and in the appended claims, the term “task” is meant to be understood broadly as a process or execution instance supported by an operating system. In one example, a task processes a number of input tuples one by one, sequentially. An operation may have multiple parallel and distributed tasks which may reside on different machine nodes. A task runs cycle by cycle continuously for transforming a stream into a new stream where in each cycle the task processes an input tuple, sends the resulting tuple or tuples to a number of target tasks, and, in some examples, acknowledges the source task where the input came from upon the completion of the computation.

Further, as used in the present specification and in the appended claims, the term “checkpoint” or similar language is meant to be understood broadly as any identifier or other reference that identifies the state of the task at a point in time.

Even still further, as used in the present specification and in the appended claims, the term “a number of” or similar language is meant to be understood broadly as any positive number comprising 1 to infinity; zero not being a number, but the absence of a number.

### DESCRIPTION OF THE FIGURES

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

In failure recovery, a window boundary may be relied on to control task rollbacks. The present systems and methods may use any number of windows, and is not limited to the above-described time windows and or a window created by a bounded number of tasks. Therefore, the present disclosure further describes “checkpointing history” and “stable checkpoint.” The sequence of checkpoints of task T is referred to as T's checkpointing history. A checkpoint is “stable” if it can be reproduced from the checkpoint history of its upstream neighbors. In the context of streaming, a stable checkpoint is backward consistent. Ensuring the stability of each checkpoint avoids the domino effects in optimistic task recovery for stream processing. A checkpointed state of task T, S_{T}, contains, among other information, the input messageIds (mids), μS_{T}, and the output messages, σS_{T}. The history of T's checkpoints is denoted by ηS_{T}, and all the output messages contained in ηS_{T} is denoted by σ ηS_{T}.

Given a pair of source and target tasks A and B, respectively, the messages from A to B in σS_{A} and ηS_{A} are denoted by σS_{A→B} and ηS_{A→B} respectively; the messageIds, μS_{T}, from A to B in μS_{B} is denoted by μS_{B←A}. A message from source task A to target task B, if checkpointed with A before emitting, is always recoverable even if A fails. Thus, the message can be resent to B in recovery of B's failure. This is the basis of pessimistic checkpointing.

A checkpointed state of the target task B, S_{B}, is stable with regard to a source task A if and only if all the messages identified by μS_{B←A} are contained in (denoted by ∝) ηS_{A→B}; that is μS_{B←A}∝ηS_{A→B}. S_{B} is totally stable if and only if S_{B} is stable with regard to all its source tasks. It is noted that if B is recovered from a failure and rolled back to a stable checkpointed state, the checkpointed input message can be identified in both tasks A and B, which becomes the protocol for A to figure out the next message to resend to B, without further propagating the search scope to the upstream tasks of A.

The present disclosure discloses the incorporation of the above concepts with the window semantics of stream processing. Specifically, for time series data, the present systems and methods provide a timestamp attribute for the stream tuples, and use a time window, such as, for example, a per minute time window, as the basic checkpoint interval. In one example, the checkpoint interval of a per time window may be user definable. For any task B and one of its source tasks A, if the checkpoint interval of A is T and the checkpoint interval of B is NT where N is an integer, then the checkpoint of B is stable with regard to A. For example, if the checkpoint interval of A is per minute (60 sec.), and the check point interval of B is 1 minute (60 sec), 10 minutes (600 sec) or 1 hour (3600 sec), then B's checkpoint is stable with regard to A. Otherwise, if B's checkpoint interval is 90 sec, for example, it is not stable with regard to A, and, in this case, if B rolls back to its latest checkpoint and requests A to resend the next message, there is no guarantee A will identify the correct message. Based on these concepts, the present systems and methods provide for WCR-based recovery methods which allow continuous per-tuple-based stream processing, with window based checkpointing and failure recovery.

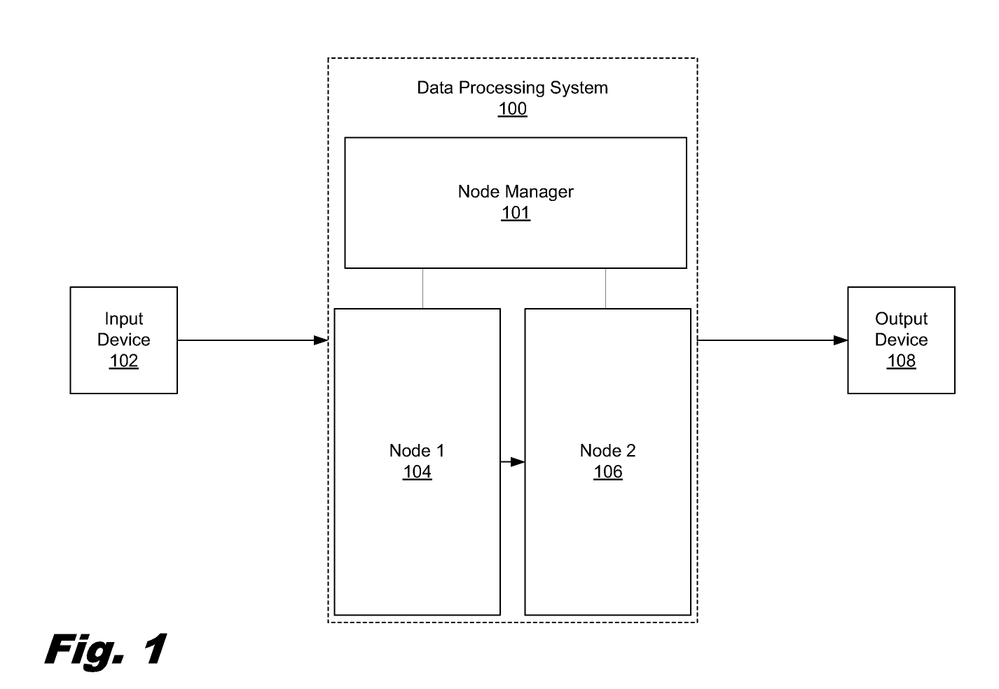

Turning now to the figures, FIG. 1 is a diagram of a data processing system (100) for window-based checkpoint and recovery data processing, according to one example of the principles described herein. The data processing system (100) accepts input from an input device (102), which may comprise data, such as records. The data processing system (100) may be a distributed processing system, a parallel processing system, or combinations thereof. In the example of a distributed system, multiple autonomous processing nodes (104, 106), comprising a number of data processing devices, may communicate through a computer network and operate cooperatively to perform a task. Though a parallel processing computing system can based on a single computer, in a parallel processing system as described herein, a number of processing devices cooperatively and substantially simultaneously perform a task. There are architectures of parallel processing systems where a number of processors are geographically near-by and may share resources such as memory. However, processors in those systems also work cooperatively and substantially simultaneously on task performance.

A node manager (101) to manage data flow through the number of nodes (104, 106) comprises a number of data processing devices and a memory. The data node manager (101) executed the checkpointing of messages sent among the nodes (104, 106) within the data processing system (100), the recovery of failed tasks within or among the nodes (104, 106), and other methods and processes described herein.

Input (102) coming to the data processing system (100) may be either bounded data, such as data sets from databases, or stream data. The data processing system (100) and node manager (101) may process and analyze incoming records from input (102) using, for example, structured query language (SQL) queries to collect information and create an output (108).

Within data processing system (100) are a number of processing nodes (104, 106). Although only two processing nodes (104, 106) are shown in FIG. 1, any number of processing nodes may be utilized within the data processing system (100). In one example, the data processing system (100) may comprise a large number of nodes such as, for example, hundreds of nodes operating in parallel and/or performing distributed processing.

Node 1 (104) may comprise any type of processing stored in a memory of node 1 (104) to process a number of records and number of tuples before sending the tuples for further processing at node 2 (106). In this manner, any number of nodes (104, 106) and their associated tasks or sub-tasks may be chained where the output of a number of tasks or sub-tasks may be the input of a number of subsequent tasks or sub-tasks.

The data processing system (100) may be utilized in any data processing scenario including, for example, a cloud computing service such as a Software as a Service (SaaS), a Platform as a Service (PaaS), a Infrastructure as a Service (IaaS), application program interface (API) as a service (APIaaS), other forms of network services, or combinations thereof. Further, the data processing system (100) may be used in a public cloud network, a private cloud network, a hybrid cloud network, other forms of networks, or combinations thereof. In one example, the methods provided by the data processing system (100) are provided as a service over a network by, for example, a third party. In another example, the methods provided by the data processing system (100) are executed by a local administrator.

As described above, the data processing system (100) utilizes optimistic, window-based checkpoint and recovery to reduce or eliminate the domino effect of rollback propagation when a task fails and a recovery process is initiated without the need to checkpoint every output message of a tasks one tuple at a time. In one example, the present optimistic recovery mechanism may be built on top of an existing distributed stream processing infrastructure such as, for example, STORM, a cross platform complex event processor and distributed computation framework developed by Backtype and owned by Twitter, Inc. STORM is a system supported by and transparent to users. The present optimistic recovery mechanism significantly outperforms a pessimistic recovery mechanism.

Thus, the present system is a real-time, continuous, parallel, and elastic stream analytics platform built on top of STORM. In one example, there are two kinds of nodes within a cluster: a “coordinator node” and a number of “agent nodes” with each running a corresponding daemon. In one example, the node manager (101) is the coordinator node, and the agent nodes are nodes 1 and 2 (104, 106). A dataflow process is handled by the coordinator node and the agent nodes spread across multiple machine nodes. The coordinator node (101) is responsible for distributing code around the cluster, assigning tasks to machines, and monitoring for failures, in the way similar to APACHE HADOOP software framework developed and distributed by Apache Software Foundation. Each agent node (104, 106) interacts with the coordinator node (101) and executes some operator instances as threads of the dataflow process. In one example, the present system platform may be built using several open-source tools, including, for example, APACHE ZOOKEEPER distributed application process coordinator developed and distributed by Apache Software Foundation, ØMQ asynchronous messaging library developed and distributed by iMatix Corporation, KRYO object graph serialization framework, and STORM, among other tools. ZOOKEEPER coordinates distributed applications on multiple nodes elastically. ØMQ supports efficient and reliable messaging, KRYO deals with object serialization, and STORM provides the basic dataflow topology support. To support elastic parallelism, the present systems and methods allow a logical operator to execute by multiple physical instances, as threads, in parallel across the cluster, and the nodes (104, 106) pass messages to each other in a distributed manner. Using the ØMQ library, message delivery is reliable, messages never pass through any sort of central router, and there are no intermediate queues.

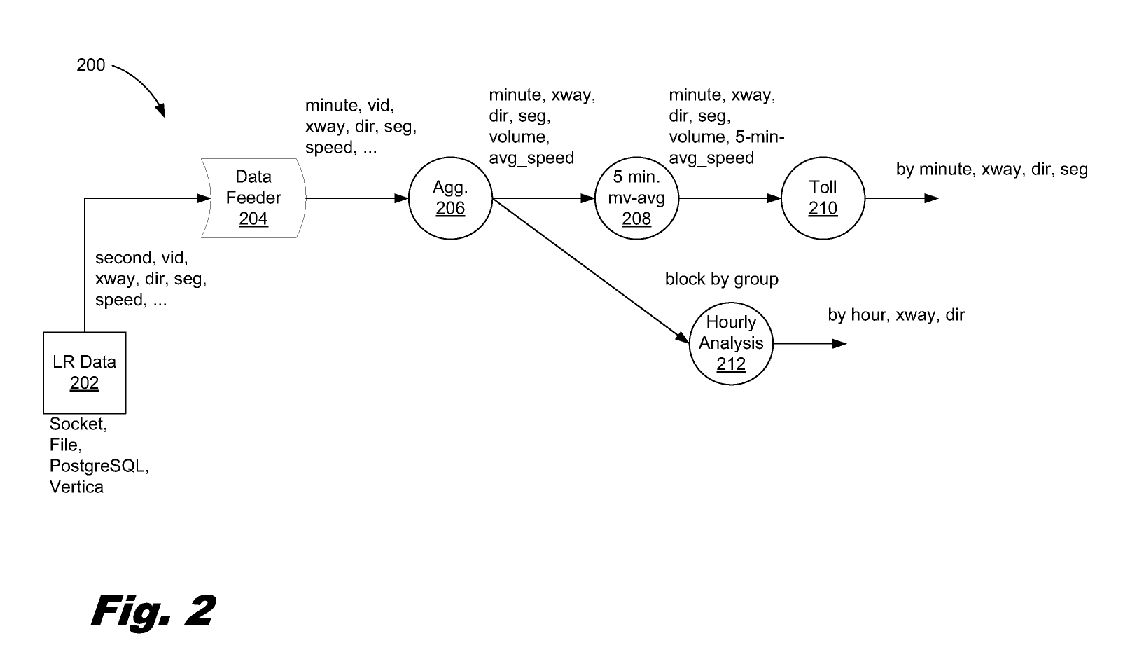

FIG. 2 is a diagram of a streaming process (200), according to one example of the principles described herein. The present systems and methods utilize a Linear-Road (LR) benchmark to illustrate the notion of stream process. Linear Road simulates a toll system for the motor vehicle expressways of a large metropolitan area. The tolling system uses “variable tolling”: an increasingly prevalent tolling technique that uses such dynamic factors as traffic congestion and accident proximity to calculate toll charges. Linear Road specifies a variable tolling system for a fictional urban area including such features as accident detection and alerts, traffic congestion measurements, toll calculations, and historical queries.

The LR benchmark models the traffic on 10 express ways; each express way comprising two directions and 100 segments. Cars may enter and exit any segment. The position of each car is read every 30 seconds and each reading constitutes an event, or stream element, for the system. A car position report has attributes “vehicle_id” (vid), “time” (in seconds), “speed” (mph), “xway” (express way), “dir” (direction), and “seg” (segment), among others. In FIG. 2, the LR data (202) is input to the data feeder (204). The LR data may comprise a time in seconds, a vehicle ID (“vid”), “xway” (express way), “dir” (direction), “seg” (segment), and speed, among others. An aggregation operation (206) is performed. With the simplified benchmark, the traffic statistics for each highway segment, such as, for example, the number of active cars, their average speed per minute, and the past 5-minute moving average of vehicle speed (208), are computed. Based on these per-minute per-segment statistics, the application computes the tolls (210) to be charged to a vehicle entering a segment any time during the next minute. As an extension to the LR application, the traffic statuses are analyzed and reported every hour (212). The stream analytics process of FIG. 2 is specified by the following JAVA programming:

```
  public class LR_Process {
...
public static void main(String[ ] args) throws Exception {
    ProcessBuilder builder = new ProcessBuilder( );
    builder.setFeederStation(“feeder”, new LR_Feeder(args[0]), 1);
    builder.setStation(“agg”, new LR_AggStation(0, 1), 6)
.hashPartition(“feeder”,
new Fields(“xway”, “dir”, “seg”));
    builder.setStation(“mv”, new LR_MvWindowStation(5),
4).hashPartition(“agg”,
new Fields(“xway”, “dir”, “seg”));
    builder.setStation(“toll”, new LR_TollStation( ),
4).hashPartition(“mv”, new Fields(“xway”, “dir”, “seg”));
    builder.setStation(“hourly”, new LR_BlockStation(0, 7),
2).hashPartition(“agg”,
new Fields(“xway”, “dir”));
    Process process = builder.createProcess( );
    Config conf = new Config( ); conf.setXXX(...); ...
    Cluster cluster = new Cluster( );
    cluster.launchProcess(“linear-road”, conf, process);
    ...
}
```

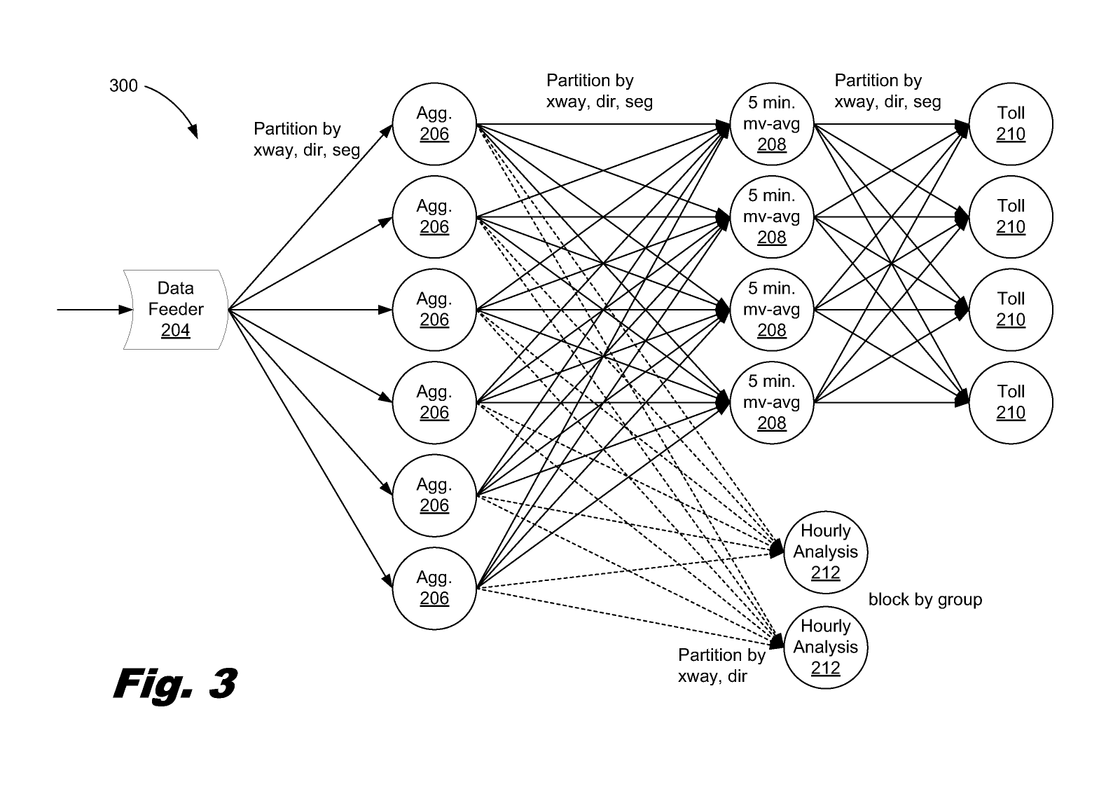

In the above topology specification, the hints for parallelization are given to the operators “agg” (6 instances) (206), “mv” (5 instances) (208), “toll” (4 instances) (210) and “hourly” (2 instances) (212). The platform may make adjustments based on the resource availability. The physical instances of these operators for data-parallel execution are illustrated in FIG. 3. FIG. 3 is a diagram of a streaming process (300) with elastically parallelized operator instances, according to one example of the principles described herein.

Turning now to failure recovery of stream processes, in a streaming process, tasks communicate where tuples passed between them are carried by messages. The failure recovery of a task is based on message logging and checkpointing, which ensure the streaming tuples are processed in the order of their generation on each dataflow path, and each task is processed once and only once. More specifically, a task is a process supported by the operating system. The task processes the input tuples one by one sequentially. On each input tuple, the task derives a number of output tuples and generates a Local State Interval (LSI), or simply state. The state of a task depends on the input-tuple, the output tuples, and the updated state. Tasks communicate through messaging. The failure recovery of tasks is based on checkpointing messages and the state. A task checkpoints its execution state and output messages after processing each input tuple, and, if failed and recovered, have the latest state restored and the input tuple re-sent for recomputation.

As described above, one protocol for checkpointing is the “pessimistic” checkpointing protocol where every output message for delivering a tuple is checkpointed before sending. In pessimistic checkpointing protocol, the message logging and emitting are synchronized. This can be done by blocking the sending of a message until the message is logged at the sender task, or by blocking the execution of a task until the message is logged at the recipient task. Recovery based on pessimistic checkpointing has some implementation issues on a modern distributed infrastructure. However, the idea is that the state of the failed task is reloaded from its most recent checkpoint, and the message originally received by the task after that checkpoint is re-acquired and resent from the source task or node to the target task or node. Any duplicate input would be ignored by the recipient target task.

Due to the nature of blocking input messages one at a time, the pessimistic protocol is very inefficient in a generally failure-free environment, particularly for real-time stream processing. To remedy the inefficiencies that are inherent in a pessimistic checkpointing protocol, the present systems and methods utilize another kind of checkpointing protocol particularly suitable for stream processing; the above-described “optimistic” checkpointing protocols, where the checkpointing is made asynchronously with the execution. Asynchronous checkpointing comprises the logging and emitting of output messages asynchronously by checkpointing intermittently with multiple messages and LSIs. When a task is re-established from a failure, its state rolls back to the last checkpoint with multiple, but an unknown number of, messages received since the last checkpoint is re-processed. Since optimistic checkpointing protocols avoid per-tuple based checkpointing by allowing checkpointing to be made asynchronously without blocking task execution, optimistic checkpointing protocols can significantly outperform pessimistic checkpointing protocols in the absence of failures. Thus, a beneficial performance trade-off in environments where failures are infrequent and failure-free performance is achieved.

However, one difficulty for supporting optimistic checkpointing is the propagation of task rollbacks for reaching a consistent global state, known as a domino effect. As described above, the domino effect is triggered for two reasons. The first reason is that the general distributed systems often focuses on global consistency, and, therefore, the rollback of a task recovered from a failure may trigger that initial rollback's dependent tasks to rollback until a globally consistency has been reached. For example, if bank A transfer a fund to bank B, and bank B rolled back during a failure recovery as if it did not receive the funds, bank A rolls back as well as if it did not send the funds in order to appropriately account for the fund transfers.

The second reason the domino effect is triggered in an optimistic checkpointing protocol is due to the lack of a commonly observable and semantically meaningful cut-off point of rollback propagation. For example, given a pair of source task and target task T_{A} and T_{B}, assume they checkpoint their state per 100 input tuples. T_{A} derives four (4) output tuples out of one input tuple and sends them to T_{B} as the input tuples of T_{B}. Further, consider the following situation:
(a) After processing 100 tuples since its last checkpoint, T_{B} checks its state including the input message, the updated state interval and the output messages, into a new checkpoint bₖ. In one example, bₖ may not be a stable checkpoint. If by then task T_{A} only processed less than 100 tuples since T_{A}'s last checkpoint, these input tuples and the output tuples have not been checkpointed with T_{A}. After point (a) T_{B} failed, restored and rolled back to bₖ and tend to request T_{A} to re-send the missing tuples since bₖ.
(b) However, T_{A} also failed and had all the output tuples since its last checkpoint missed. Since those tuples were not checkpointed, even after T_{A} recovered by rolling back to its previous checkpoint, it cannot identify and resend the tuple requested by T_{B}.
(c) As a result, both T_{A} and T_{B} further rollback to a possible common synchronized point. Such rollback propagation is uncontrolled. In a worst case, both tasks have to roll back to the very beginning.

Motivated by applying optimistic checkpointing for the failure recovery of stream processing, the present systems and methods first adopt the notion of “eventual consistency.” In the above example of bank A and bank B, instead of first having bank A rolled back for reaching a globally consistent state instantly, bank A re-sends the message to bank B for updating B's state, to reach a globally consistent state “eventually.” Further, the present systems and methods provide a commonly observable and semantically meaningful cut-off point of rollback propagation.

To support optimistic checkpointing in the way suitable for stream processing, the present systems and methods utilize continued stream processing with window-based checkpoint and recovery (WCR). WCR improves the performance in failure free stream processing; while adding some recovery complexity, and significantly reduces the overall latency since failure is relatively rare in the overall course of processing data streams.

With the WCR-based failure recovery protocol, checkpointing is made asynchronously with the execution of tasks. While the stream processing is still made tuple by tuple, checkpointing is performed once per-window with multiple input tuples and LSIs. In one example, the window is a time window where checkpointing is performed at defined intervals of time. In one example, the time window is user-definable. When a task T is re-established from a failure in a window boundary w, its last checkpointed state is restored. The messages T received since then, in w up to the most recent messages in all input channels, are requested by T and resent by T's upstream tasks. The benefits gained from WCR protocol is the avoidance of processing overhead caused by per-tuple based checkpointing and, for at least this reason, outperforms pessimistic checkpointing protocols in scenarios where failures are relatively rare.

WCR protocol is characterized by a number of features. WCR protocol relies on window boundaries to synchronize the checkpoints of chained tasks to avoid the above-described domino effects, and, in turn, making the rollback propagation well controlled. WCR protocol applies the notion of optimistic checkpointing in the way suitable for stream processing. That is WCR protocol is based on the notion of “eventual consistency,” rather than pursuing an instant globally consistent state. WCR protocol is different from batch processing in that WCR protocol allows each task to perform per-tuple based stream processing, and emits results continuously but with batch oriented checkpointing and recovery.

To describe the optimistic checkpointing more formally, present application introduces a number of concepts. Checkpointing history is a sequence of checkpoints of a task T, and is referred to as T's checkpointing history. A stable checkpoint is a checkpoint that can be reproduced from the checkpoint history of its upstream neighbor tasks. In the context of streaming, a stable checkpoint is backward consistent. The stability of the checkpointed state may be described as follows. A checkpointed state of task T, S_{T}, contains, among other information, the input messageIds (mids), μS_{T}, and the output messages, σS_{T}. The history of T's checkpoints may be denoted by ηS_{T}, and all the output messages contained in ηS_{T} may be denoted by σ ηS_{T}.

Given a pair of source and target tasks A and B, the messages from A to B in σS_{A} and ηS_{A} are denoted by σS_{A→B} and ηS_{A→B}, respectively. Further, the mids from A to B in μS_{B} may be denoted by μS_{B←A}. A message from source task A to target task B, if checkpointed with A before emitting, is always recoverable even if A fails, and, thus, can be resent to B in recovery B's failure. This is the basis of pessimistic checkpointing.

A checkpointed state of the target task B, S_{B}, is stable with regard to a source task A if and only if all the messages identified by μS_{B←A}, d, denoted by ∝, are contained in ηS_{A→B}. That is, μS_{B←A}∝ηS_{A→B}. S_{B} is totally stable if and only if S_{B} is stable with regard to all its source tasks. If B is recovered from a failure and rolled back to a stable checkpointed state, the checkpointed input message can be identified in both tasks A and B. It then becomes the protocol for A to figure out the next message to resend to B, without further propagating the search scope to the upstream tasks of A.

Therefore, ensuring the stability of each checkpoint avoids the domino effects in optimistic task recovery. In the context of stream processing, the present systems and methods incorporate this with the common chunking criterion. Specifically, for time series data, the present systems and methods provide a timestamp attribute for the stream tuples, and use a time window, such as per minute time window, as the basic checkpoint interval. For any task B and one of its source tasks A, if the checkpoint interval of A is T and that of B is NT where N is an integer, then the checkpoint of B is stable with regard to A. For instance, if the checkpoint interval of A is per minute (60 sec), and that of B is 1 minute (60 sec), 10 minutes (600 sec), or 1 hour (3600 sec), then B's checkpoint is stable with regard to A. Otherwise, if B's checkpoint interval is 90 sec, it is not stable with regard to A. In that case, if B rolls back to its latest checkpoint, and requests A to resend the next message, there is no guarantee A will be able to identify that message.

Although a data stream is unbounded, applications often require those infinite data to be analyzed granularly. Particularly, when the stream operation involves the aggregation of multiple events, for semantic reasons, the input data is punctuated into bounded chunks. Thus, in one example, execution of such an operation is performed epoch by epoch to process the stream data chunk by chunk. This provides a fitted framework for supporting WCR. For example, in the previous Linear Road benchmark model example, the operation “agg” aims to deliver the average speed in each express-way's segment per minute time-window. Then the execution of this operation on an infinite stream is made in a sequence of epochs, one on each of the stream chunks. To allow this operation to apply to the stream data one chunk at a time, and to return a sequence of chunk-wise aggregation results, the input stream is cut into 1 minute (60 seconds) based chunks, say S₀, S₁, . . . Sᵢ, . . . such that the execution semantics of “agg” is defined as a sequence of one-time aggregate operations on the data stream input minute by minute.

Given an operator, O, over an infinite stream of relation tuples S with a criterion θ for cutting S into an unbounded sequence of chunks such as, for example, by every 1-minute time window, <S₀, S₁, . . . , Sᵢ, . . . > where Sᵢ denotes the i-th “chunk” of the stream according to the chunking-criterion θ, the semantics of applying O to the unbounded stream S lies in the following equation:

Q(S)→<Q(S₀), . . . Q(Sᵢ), . . . > Eq. 1

which continuously generates an unbounded sequence of results, one on each chunk of the stream data.

Punctuating an input stream into chunks and applying an operation in an epoch by epoch manner to process the stream data chunk by chunk, or window by window, is a template behavior. Thus, the present systems and methods consider it as a kind of meta-property of a class of stream operations and support it automatically and systematically by our operation framework. The present systems and methods host such operations on the epoch station or the operations sub-classing the epoch station, and provide system support in the following aspects. Several types of stream punctuation criteria are specifiable, including punctuation by cardinality, by timestamps and by system-time period, which are covered by the system function public boolean nextChunk(Tuple, tuple) to determine whether the current tuple belongs to the next window or not.

The paces of dataflow with regard to timestamps may be different at different operators. For example, the “agg” operator is applied to the input data minute by minute, and so are some downstream operators of it. However, the “hourly analysis” operator is applied to the input stream minute by minute, but generates output stream elements hour by hour.

There exist two ways to use the epoch station. A first way to use the epoch station is to do batch operation on each chunk of input data falling in a time-window. In this case, the output will not be emitted until the window boundary is reached. A second way to use the epoch station is to operate and emit output on the per-tuple basis, but do checkpointing on the per-window basis. In this second way, the WCR recovery mechanism is well fit in.

In the present platform, a task runs continuously for processing input tuple by tuple. The tuples transmitted via a dataflow channel are sequenced and identified by a segment number, seq#, and guaranteed to be processed in order. For example, a received tuple, t, with seq# earlier than expected will be ignored, and a received tuple, t, with seq# later than expected will trigger the resending of the missing tuples to be processed before t. In this way a tuple is processed once and only once and in the restrict order. For efficiency, a task does not rely on acknowledgement signals “ACK” to move forward. Instead, acknowledging is asynchronous to task executing as described above, and is only used to remove the already emitted tuples not needed for resending any more. Since an ACK triggers the removal of the acknowledged tuple and all the tuples prior to that tuple, the ACK is allowed to be lost and not resent. With optimistic checkpointing, the task state and output tuples are checkpointed on the per window bases. In one example, the resending of tuples is performed via a separate messaging channel that avoids the interruption of the normal message delivery order by task recovery.

A task is a continuous execution instance of an operation hosted by a station where two major methods are provided. One method is the prepare( )method that runs initially before processing input tuples for instantiating the system support (static state) and the initial data state (dynamic state). Another method is execute( ) for processing an input tuple in the main stream processing loop. Failure recovery is handled in prepare( )since after a failed task restored it will experience the prepare( ) phase first.

As mentioned above, under the pessimistic checkpointing approach, for a task T, checkpointing is synchronized with the per-tuple processing and output messaging. During the regular stream processing, after the processing of an input tuple, t, is completed, the application oriented and system oriented states, as well as the output tuples, are checkpointed. The source task at the upstream, Tₛ, that sends input tuple t, is acknowledged about the completion of t, and the output tuple is emitted to a number of recipient tasks. During the recovery, task T is restored and rolled back to its latest checkpointed state, its last output tuples are re-emitted, and the latest input message IDs in all possible input channels are retrieved from the checkpointed state. The corresponding next input in every channel is requested and resent from the corresponding source tasks. The resent tuples are processed first before task T proceeds to the execution loop.

In contrast to the above pessimistic recovery approach, the present optimistic WCR protocol, for a task T, checkpointing is asynchronized with the per-tuple processing and output messaging. During the regular stream processing, the stream processing is still performed tuple by tuple with outputs emitted continuously. However, the checkpointing is performed once per window within the parameters of the window. For example, if the window is a time window, checkpointing would be performed sometime during the time window, and by the end of the time window. In one example, the time window information may be derived from each tuple. In another example, the state and generated output stream for a time window are checkpointed upon receipt of the first tuple belonging to the next time window.

After checkpointed, the completion of stream processing in the whole time window is acknowledged. Specifically, for each input channel, the latest input message ID is retrieved and acknowledged. This is performed instead of acknowledging all the input tuples falling in that window as well. This is because on the source task side, upon receipt of the ACK for a tuple, that tuple and all the tuples before it will be discarded from the output buffer. During the recovery, task T is restored and rollback to its latest checkpointed state. Since the checkpointing takes place upon receipt the first tuple of the next window, its output tuples for the checkpointed window were emitted, and, therefore, have no need to be re-emitted. However, all the input and output messages in the failed window have been lost, not limited to the latest one. Therefore, for every input channel, all the input tuples, up to the current recorded input tuples in the failed window are resent by the corresponding source tasks via all the possible input channels.

In a streaming process, the recoverable tasks under WCR are defined with a base window unit T being defined as, for example, one minute, and the following three variables. w_{current} defined as the current base window sequence number. In one example, w_{current} has a value of 0 initially. w_{delta}: is defined as the window size by number of T. For example, the value of w_{delta}: may be 5 indicating 5 minutes. w_{ceiling} is defined as the starting sequence number of the next window by number of T, and, in one example may have a value of 5.

Further, at least two functions are defined (where t is a tuple). First, fw_{current} (t) returns the current base window sequence number. Second, fwₙₑₓₜ(t) returns a boolean for detecting whether the tuple belongs to the next window.

The failure recovery is performed by recovered task, T, sending a number of RESEND requests to the source tasks in all possible input channels. In each channel, the source task, Tₛ, upon receipt the above request, locks the latest sequence number of the output tuple, tₕ, that has not been emitted to task T. Tₛ resends T all the output tuples up to tₕ. The resent tuples are processed by T sequentially. The above processes are performed per input channel, before task T proceeds to an execution loop.

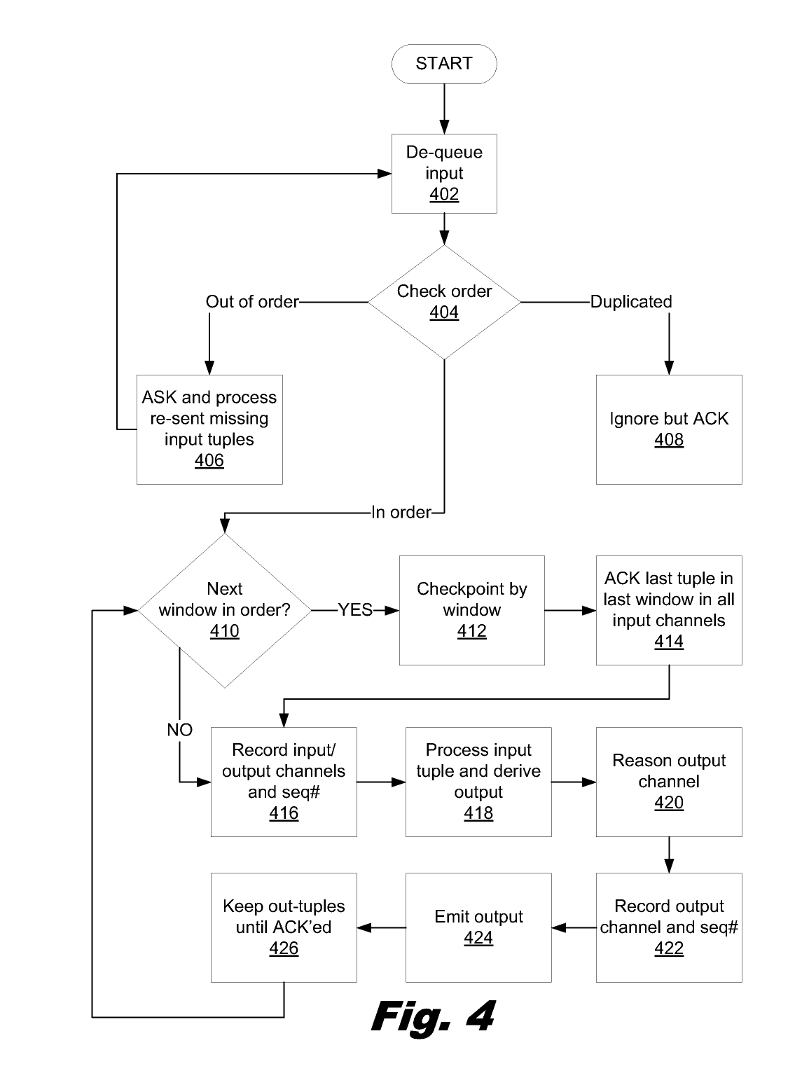

Execute( ) is depicted in FIG. 4. FIG. 4 is a flowchart showing task execution utilizing window-based checkpoint and recovery (WCR), according to one example of the principles described herein. The method may begin by de-queuing (block 402) a number of input tuples. The seq# of each input tuple, t, is checked (block 404) as to order of the tuple. If t is a duplicate indicating the tuple has a smaller seq# than expected (block 404, determination “Duplicated”), it will not be processed again and ignored, but will be acknowledged (block 408) to allow the sender to remove t and the ones earlier than t. If t is instead “jumped” indicating the tuple has a seq# larger than expected (block 404, determination “out of order”), the missing tuples between the expected one and t will be requested, resent, and processed (block 406) first before moving to t. The method then returns to block 402 for the next input tuple.

If t is in order (block 404, determination “in order”), then the method determines if the tuples within the next window are in order (block 410). If the system (100) determines that the tuples within the window are in order (block 410, determination YES), then the state and results are checkpointed per-window (block 412). The checkpointed object comprises a list of objects. When checked-in, the list is serialized into a byte-array to write to a binary file as a ByteArrayOutputStream. When checked-out, the byte-array obtained from the ByteArrayInputStream of reading the file is de-serialized to the list of objects representing the state.

After checkpointing, the window-oriented transaction is committed, with the latest input tuple in each input channel, say t_{w}, acknowledged (block 414), which, on the sender side, has the effect for all the output tuples in that channel prior to t_{w} to be acknowledged. The input/output channels and seq# are recorded (block 416) as part of the checkpointed state. The input tuples are processed (block 418), and the output channels are “reasoned” (block 420) for checkpointing them to be used in a possible failure-recovery scenario. The output channels and seq# are recorded (block 422) as part of the checkpointed state, and the output is emitted (block 424). Since each output tuple is emitted only once, but possibly distributed to multiple destinations unknown to the task before emitting, the output channels are “reasoned” for checkpointing them to be used in the possible failure-recovery, which is described in more detail below. The method keeps (block 426) out-tuples until and ACK message is sent. Then the method may return to determining (block 410) if the next window is on order, and the method loops in this manner.

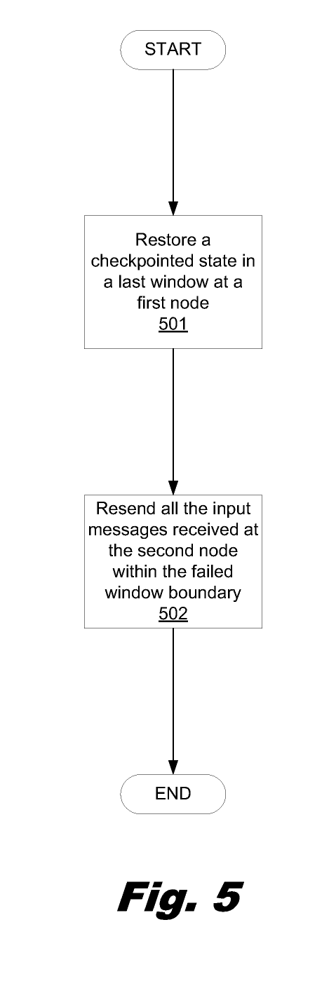

FIG. 5 is a flowchart showing task recovery utilizing window-based checkpoint and recovery (WCR), according to one example of the principles described herein. The method may begin by restoring (block 501) a checkpointed state in a last window at a first node. All the input messages received at a second node within the failed window boundary are resent (502) for recalculation.

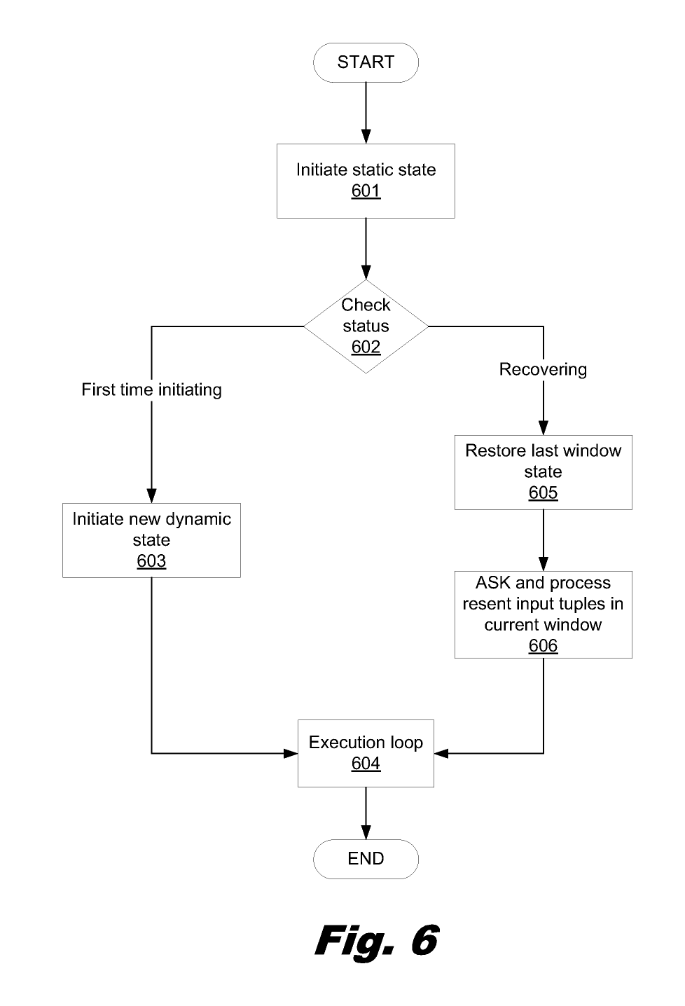

FIG. 6 is a flowchart showing task recovery utilizing window-based checkpoint and recovery (WCR), according to another example of the principles described herein. The method may begin by initiating (block 601) a static state. The status of a task is then checked (block 602) to determine if the system (100) is initiating for the first time or in a recovery process brought on by a failure in the task. If the system (100) determines that the status is a first time initiation (block 602, determination “first time initiating”), then the system initiates a new dynamic state (block 603), and processing moves to the execution loop (block 604) as described above in connection with FIG. 4.

If, however, the system (100) determines that the status is a recovery status (block 602, determination “recovering”), then the system rolls back to the last window state by restoring (block 605) a last window state and sending (block 606) an ASK request and processing resent input tuples in the current window up to the current tuple. Processing moves to the execution loop (block 604) as described above in connection with FIG. 4.

Once a failure occurs, the failed task instance is re-initiated on an available machine node by loading the serialized task class to the selected node and create a new instance that is supported by the underlying streaming platform. Since transactional streaming deals with chained tasks, not only the computation results but also the messages for transferring the computation results between cascading tasks are taken into account. Because a failure may cause the loss of input tuples potentially from any input channel, the recovered task asks each source task to resend the possible tuples in the window boundary where the failure occurs, based on the method described above in connection with FIG. 4. The prepare( ) will now be described in connection with FIG. 6.

An architectural feature for supporting checkpointing-based failure recovery (either pessimistic or optimistic) of streaming tasks will now be described. A stream is an unbounded sequence of tuples. A stream operator transforms a stream into a new stream based on its application-specific logic. The graph-structured stream transformations are packaged into a “topology” which is a top-level dataflow process. When an operator emits a tuple to a stream, it sends the tuple to every successor operator subscribing to that stream. A stream grouping specifies how to group and partition the tuples input to an operator. There exist a few different kinds of stream groupings such as, for example, hash-partition, replication, random-partition, among others.

In order to request and resend the missing tuple during a recovery, the recovered task, as the recipient of the missing tuple, and the source task, as the sender, comply with the seq# of the missing tuple. Therefore, the sender records the seq# before emitting. This is a paradox since the sender does not know the exact destination before emitting, given that the touting is responsible by the underlying infrastructure. In fact, this is a common issue in modern distributed computing infrastructure.

As mentioned above, the information about input/output channels and seq# is represented by the “MessageId,” or “mid,” composed as srcTaskId̂targetTaskId-seq#, such as “a.8̂b.6-134” where a and b are tasks. However, tracking a matched mid is not to record and find the equal mids on the sender side and the recipient side since this is impossible when the grouping criteria are enforced by another system component. However, the recorded mid is to be logically consistent with the mid actually emitted, and the recording is to be performed before emitting. This is because the source task does not wait for ACK in rolling forward, and ACKs are allowed to be lost. This paradox is addressed by the present systems and methods.

For guiding channel resolution, the present systems and methods extract from the streaming process definitions of the task specific meta-data, including the potential input and output channels as well as the grouping types. The present systems and methods also record and keep updated for each task the message seq# in every input and output channel as a part of its checkpoint state. Thus, the present application introduces the notion of “mid-set” to identify the channels to all destinations of an emitted tuple. A mid-set is recorded with the source task and included in the output tuple. Each recipient task picks up the matched mid to record the corresponding seq#. Mid-sets only appear in and are recorded for output tuples. On the recipient side, the mid-set of a tuple is replaced by the matched mid to be used in both ACK and ASK processes. A logged tuple matches a mid in the ACK or ASK message can be found based on the set-membership relationship.

Further, the present application introduces the notions of “task alias” and “virtual mid” to resolve the destination of message sending with “fields-grouping,” or hash partition. In this case, the destination task is identified by a unique number yield from the hash and modulo functions as its “alias.”

Below is described these notions in more detail with regard to a number of grouping types. First, with “all-grouping,” a task of the source operation sends each output tuple to multiple recipient tasks of the target operation. Since there is only one emitted tuple but multiple physical output channels, a “MessageId Set”, or “mid-set” to identify the sent tuple is utilized. For instance, a tuple sent from b.6 to c.11 and c.12 is identified by {b.6̂c.11-96, b.6̂c.12-96}. On the sender site, this mid-set is recorded and checkpointed. On the recipient site, only the single mid matching the recipient task will be extracted, recorded and used in ACK and in ASK messages. The match of the ACK or ASK message identified by a single mid and the recorded tuple identified by a mid-set is determined by set membership. For example, the ACK or ASK message with mid b.6̂c.11-96 or b.6̂c.12-96 matches the tuple identified by {b.6̂c.11-96, b.6̂c.12-96}.

With “fields-grouping”, the tuples output from the source task are hash-partitioned to multiple target tasks, with one tuple going to one destination only with regard to a single target operation. This is similar to having Map results sent to Reduce nodes. With the underlying streaming platform, the hash partition index on the selected key fields list, “keyList,” over the number of k tasks of the target operation, is calculated by keyList.hashcode( )% k. Then the actual destination is determined using a network replicated hash table that maps each hash partition index to a physical task, which, however, is out of the scope of the source task.

A task alias for identifying the target task, and a “virtual mid” for identifying the output tuple are utilized as mentioned above. With a tuple t distributed with fields-grouping, the alias of the target task is t's hash-partition index. A virtual mid is one with the target taskId replaced by the alias. For example, the output tuples of task “a.9” to tasks “b.6” and “b.7” are under “fields-grouping” with 2 hash-partitioned index values 0 and 1. These values, 0 and 1, serve as the aliases of the recipient tasks. The target tasks “b.6” and “b.7” can be represented by aliases “b.0@” and “b.1@” without ambiguity since, with fields-grouping, the tuples with the same hash-partition index belong to the same group and always go to the same recipient task. Only one task per operation will receive the tuple, and there is no chance for a mid-set to contain more than one virtual-mid with regard to the same target operation.

A virtual mid, such as a.9̂b.1@-2, can be composed with a target task alias that is directly recorded at both source and target tasks, and is used in both ACK and ASK messages. There is no need to resolve the mapping between task-alias and task-Id. In case an operation has two or more target operations, such as in the above example where the operation “tr” has 2 target operations, “b” and “d,” an output tuple can be identified by a mid-set containing virtual-mids; for instance, and an output tuple from task “a.9” is identified by the mid-set {a.9̂d.0@-30, a.9̂b.1@-35}. This mid-set expresses that the tuple is the thirtieth tuple sent from “a.9” to one of the task d, and the thirty-fifth to one of the gemm (general matrix multiplication) task. The recipient task with alias d.0@ can extract the matched virtual-mid a.9̂d.0@-30 based on the match of operation name “blas,” or for recording the seq#30, among others.

With “global-grouping,” a tuple is routed to only one task of the recipient operation. The selection of the recipient task is taken by a separate routing component outside of the sender task. The goal is for the sender task to record the physical messaging channel before a tuple is emitted. For this purpose, the present systems and methods do not need to know what the exact task is, but just consider all the output tuples belonging to the same group that is sent to the same task, and create a single alias to represent the recipient task.

With “direct grouping,” a tuple is emitted using the emitDirect API with the physical taskId (more exactly, task#) as one of its parameters. For channel specific recovery, the present systems and methods modify all other grouping types map to direct grouping where, for each emitted tuple, the destination task is selected based on load such as. In one example, the destination currently with least load may be selected. The channel resolution problem for fields-grouping cannot be handled using emitDirect since the destination is unknown and cannot be generated randomly.

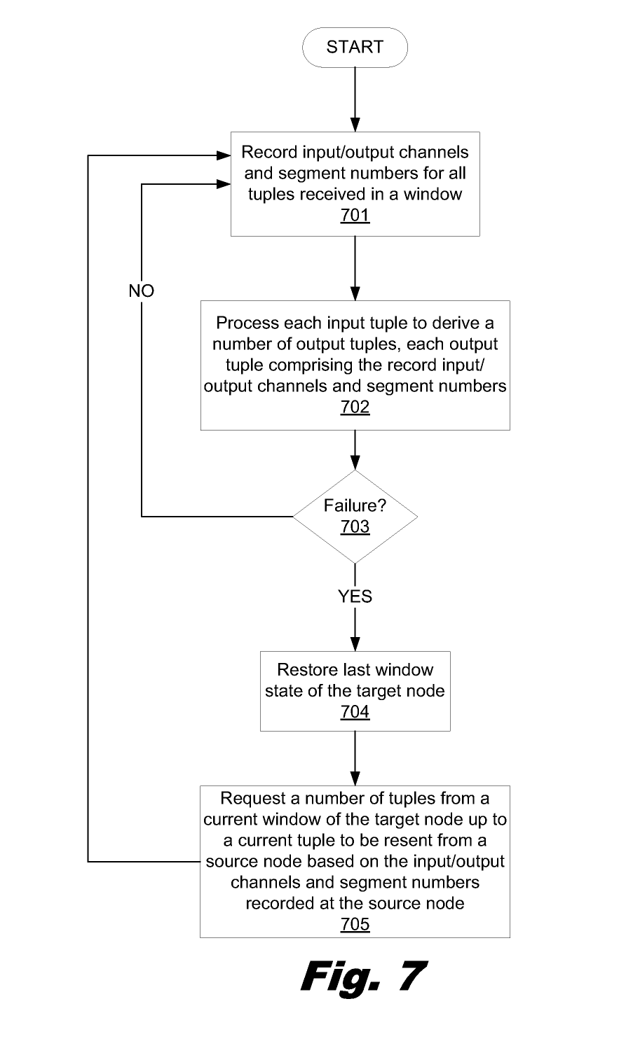

FIG. 7 is a flowchart showing task recovery utilizing window-based checkpoint and recovery (WCR), according to still another example of the principles described herein. The method of FIG. 7 may begin by recording (block 701) input/output channels and segment numbers for all tuples received in a window. Each input tuple is processed (block 702) to derive a number of output tuples, each output tuple comprising the record input/output channels and segment numbers.

The method determines (block 704) if a failure has occurred at a target node as a recipient of the output tuple. If it is determined that a failure has not occurred (block 703, determination NO), then the process may loop back to block 701 where the target node now records (block 701) input/output channels and segment numbers for all tuples received in a window. In this manner, a number of chaining nodes or tasks may provide a checkpoint for any subsequent tasks or nodes.

If it is determined that a failure has occurred (block 703, determination YES), then the last window state of the target node is restored (block 704). The system (100) requests (block 705) a number of tuples from a current window of the target node up to a current tuple to be resent from a source node based on the input/output channels and segment numbers recorded at the source node. The method may loop back to block 701 where the target node now records (block 701) input/output channels and segment numbers for all tuples received in a window for checkpointing for any subsequent nodes. Thus, the tuples are guaranteed to be processed once and only once and in order,

In summary, with the above mechanisms, message channels are tracked and recorded with regard to various grouping types. For “all-grouping,” msgId-set is used. For “fields-grouping,” task-alias and virtual-msgId are used. The present systems and methods support “direct-grouping” systematically, rather than letting a user decide, based on load-balancing such as by selecting the target task with the least load or least seq#. Further, the present systems and methods convert all other grouping types, which are random by nature, to a system-supported direct grouping. The channels with “fields-grouping” cannot be resolved by having it turned to direct-grouping. The combination of mid-set and virtual mid allows the present systems and methods to track the messaging channels of the task with multiple grouping criteria.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the data processing system (100) or other programmable data processing apparatus, implement the functions or acts specified in the flowchart and/or block diagram block or blocks. In one example, the computer usable program code may be embodied within a computer readable storage medium; the computer readable storage medium being part of the computer program product.

The specification and figures describe a method and system of recovering a failure in a data processing system comprising restoring a checkpointed state in a last window, and resending all the input messages received at the second node during the failed window boundary. A system for processing data, comprising a processor, and a memory communicatively coupled to the processor, in which the processor, executing computer usable program code checkpoints a number of states and a number of output messages once per a window, emits the output tasks to a second node, and if one of the output tasks fails at the second node restores the checkpointed state in a last window, and resends all the input messages received at the second node during the failed window boundary. These methods and systems for recovering a failure in a data processing system may have a number of advantages, including: (1) providing for continuous emission of output tuples with checkpointing in a window; (2) provides a more efficient data processing system and method by checkpointing in a batch-oriented manner, and (3) eliminates uncontrolled propagation of task rollbacks, among other advantages.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method of recovering a failure in a data processing system comprising:
at a source node, recording input/output channels and segment numbers for all tuples received in a window;
processing each input tuple to derive a number of output tuples, each output tuple comprising the recorded input/output channels and segment numbers; and
if a failure occurs at a target node:
restore a last window state of the target node; and
request a number of tuples from a current window of the target node up to a current tuple to be resent from a source node based on the input/output channels and segment numbers recorded at the source node.

2. The method of claim 1, further comprising checkpointing the states and a number of output messages once per window.

3. The method of claim 2, in which checkpointing the states and a number of output messages once per window comprises checkpointing the states and a number of output messages once per window after processing a last input tuple within the window.

4. The method of claim 1, in which checkpointing the execution state and the output message for each output task is performed asynchronously with respect to the derivation of the output tuples.

5. The method of claim 1, in which recording input/output channels and segment numbers is performed before emitting the output tuples.

6. The method of claim 1, further comprising:
at the target node, recording input/output channels and segment numbers for all tuples received in a window; and
processing each input tuple to derive a number of output tuples, each output tuple comprising the recorded input/output channels and segment numbers,
in which the checkpoint interval for a target task is an integer of the checkpoint interval of the source task.

7. The method of claim 6, in which the method is implemented on top of an existing distributed stream processing infrastructure.

8. The method of claim 6, in which the input tasks and output tasks are communicated through messaging.

9. The method of claim 1, in which the method is performed while continuously processing a stream per-tuple,

10. A system for processing data, comprising:
a processor; and
a memory communicatively coupled to the processor, in which the processor, executing computer usable program code:
checkpoints a number of states and a number of output messages once per window;
emits the output tasks to a second node; and
if one of the output tasks fails at the second node:
restores the checkpointed state in a last window; and
resends all the input messages received at the second node during the failed window boundary based on input/output channels and segment numbers recorded at the first node.

11. The system of claim 10, in which the window is defined by a number of messages sent.

12. The system of claim 11, in which the window defined by the number of messages sent is user-definable.

13. The system of claim 10, in which the system is provided as a service over a network.

14. A computer program product for recovering a failure in a data processing system, the computer program product comprising:
a computer readable storage medium comprising computer usable program code embodied therewith, the computer usable program code comprising:
computer usable program code to, when executed by a processor, receive a number of input tasks at a first node of a data processing system, the input tasks comprising a number of input tuples;
computer usable program code to, when executed by the processor, for each of the number of input tuples, derive a number of output tuples for a number of output tasks;
computer usable program code to, when executed by the processor, generate a number of states for a number of the output tasks;
computer usable program code to, when executed by the processor, checkpoint the states and a number of output messages once per window;
computer usable program code to, when executed by the processor, emit the output tasks to a second node; and
if one of the output tasks fails:
computer usable program code to, when executed by the processor, restore a checkpointed state in a last window boundary; and
computer usable program code to, when executed by the processor, resend all the input messages received at the second node during the failed window boundary based on input/output channels and segment numbers recorded at the source node and appended to the emitted output tasks.

15. The computer program product of claim 14, further comprising computer usable program code to, when executed by the processor, store data associated with window boundaries to synchronize the checkpoints of the tasks.

16. The computer program product of claim 14, in which the window is a time window.
